(19) United States
(12) Patent Application Publication
(10) Pub. No.: US 2007/0159629 A1
(43) Pub. Date: Jul. 12, 2007

(54) Ellipsometric biosensor comprising an amplification layer

(75) Inventors: Andreas Eing, Gottingen (DE); Max Wiki, Ecublens (CH); Johannes Edlinger, Feldkirch (AT); Dirk Hoenig, Gottingen (DE)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 10/598,693

(22) PCT Filed: Mar. 7, 2005
(86) PCT No.: PCT/CH05/00136

§ 371 Date: Nov. 13, 2006

Related U.S. Application Data
(60) Provisional application No. 60/551,290, filed on Mar. 8, 2004.

(51) Int. Cl. G01J 4/00

(52) U.S. Cl. 356/369

(57) ABSTRACT

A method for analyzing organic adsorbent layers (7) on a substrate (4) comprises the steps of providing a substrate (4) whose surface has an index of refraction equal or close to the index of refraction of the organic adsorbent to be analyzed. On the surface of the substrate (4) there is applied a layer system (5,6) with at least one layer (5) with index of refraction of the biological material and an organic adsorbent layer (7) on top of the layer system. When acting polarized light upon the substrate a change of polarization characteristics in reflection and/or transmission is detected.

### TECHNICAL FIELD

This invention relates to biosensors for the detection of adsorption and binding processes of biologically relevant molecules at a surface.

### BACKGROUND ART

The detection of binding reactions of biologically relevant molecules, e.g. antibody-antigen reactions play an important role in many biotechnology applications like pharmaceutical drug screening. To monitor such reactions, photometric detection using a fluorescent label attached to at least one of the involved molecular species is common art.

However, besides the additional effort to label the molecules, the presence of such markers is suspected to alter the reaction kinetics. Therefore, marker-free detection schemes that do not require the attachment of markers like fluorescent labels, nanoparticles or radiating markers to the molecules of interest are gaining increasing importance.

Several marker-free detection schemes have been developed which allow a direct detection of a binding reaction or, more generally, the adsorption or sedimentation of molecules at a surface. The surface may be tailored to be chemically specific. In the case of an immuno-reaction this may be accomplished by the immobilisation of antibodies to a chemically pre-treated surface and the subsequent binding of antigenes from a solution which is probed with a suitable detection system. Detection may take place with the sensing surface in contact to a solution or against air, after prior removal of the solutions. Instruments that allow a detailed monitoring of the adsorption kinetics are known, as well as binary detection schemes where the absence or presence of a certain molecular species is being probed.

In particular, optical detection techniques have been applied successfully, allowing a remote, non-contact sensing. A common feature of many of these techniques is a measurement of the change of the intensities, the phase or state of polarization of the probing light upon reflection at the examined surface or in transmission or combinations thereof. This primary physical effect is caused by the change of the optical thickness of the adsorption layer, either due to a change in the dielectric properties of the layer or the geometric layer thickness or both.

Ellipsometry is a well-known technique to determine the thickness of an optical layer, or changes thereof during a growth process. It sensitively measures the change of the state of polarization when electromagnetic radiation is reflected or transmitted by a sample. A classical embodiment of such an apparatus is given by a light source that emits a collimated light beam passing a variable polarisation controller given by the combination of a linear polariser (P) and an compensator in the form of a quarter-wave plate (C). The polarised light beam is incident on the sample (S) under a known oblique angle, reflected from the sample surface and analyzed by a second linear polarizer (A) with the help of a photodetector. In this PCSA ellipsometer setup the measurement may be done by changing the azimuths of the components P and A, while the optical axis of C is kept at a constant azimuth, e.g. at 45° with respect to the plane of incidence, until the photodetector receives a minimum of intensity. The azimuthal angles of the components P, C and A for this “nulling” condition may be used to calculate the ellipsometric angles Delta and Psi which are specific for the optical parameters of the sample at a given angle of incidence and wavelength of light. Using a suitable optical model and numerical regression, the quantities Delta and Psi may be recalculated in terms of the thickness of the optical layer, or changes thereof during a growth process.

Besides this classical Nulling Ellipsometer, many other forms of ellipsometers have been realized, some of which measuring only one of the two ellipsometric angles or systems that account for depolarization effects.

The application of ellipsometry for monitoring of binding reactions of biological molecules dates back to 1942 (A. Rothen, K. Landsteiner, J. Exp. Med 76, 437 (1942)). The amount of adsorbed biological material at a surface during a binding reaction may be recalculated from the quantities Delta and Psi.

Prior art is also imaging ellipsometry (U.S. Pat. No. 5,076,696) which uses spatially resolving detector and imaging optics to allow for a massively parallel measurement of ellipsometric data, e.g. in the form of Delta and/or Psi maps. Such maps may in turn be converted into surface maps of layer thickness, optical index of refraction, chemical composition or the amount of adsorped material. Frequently, biosensors are designed in the form of an array of spots or wells to allow high throughput screening of a multiple of molecular species simultaneously. Imaging ellipsometry with its intrinsic parallel detection scheme may be used avantageously as a detection technique for these so-called biochips, microarrays or microplates (A. Eing, M. Vaupel, Imaging Ellipsometry in Biotechnology, 2002, ISBN 3-9807279-6-3).

Imaging ellipsometry has been demonstrated with light employed for the measurement impinging on the surface to be measured coming from the ambient medium. Other measurement setups are based on total internal reflection as described for example in U.S. Pat. No. 6,594,011. Here the light from a light source is directed through an internal reflection element to reflect off the specimen to be detected.

As the amount of adsorbed material is usually very small, equivalent to thickness changes in the range of nanometers or below, and many interesting materials like proteins or DNA do not exhibit a significant optical absorbance in the easily accessible UV-VIS-NIR wavelength regime, very often the signal response for optical detection is not high enough, thereby limiting sensitivity.

Therefore, some imaging ellipsometers use surface plasmon resonance (SPR) in order to increase the signal response for optical detection. SPR uses a thin metal layer to allow the excitation and propagation of surface plasmons. While one side of the metal layer is in contact with a transparent support structure, usually attached to a prism allowing to couple-in light under an oblique angle, the other side of the layer is exposed to the ambient medium. Changes in the optical index of refraction in the ambient by the formation of an adsorbent layer are monitored as a shift in the angle of incidence that generates surface plasmon resonance, causing a change of reflected light intensity.

For SPR based sensors it is known that an intermediate dielectric layer between the metal film and the probed surface may act as a means to further increase the sensitivity, as for example described in U.S. Pat. No. 5,999,148. This patent describes the usage of such an intermediate layer including high-optical index of refraction oxides and notes the importance of a certain layer thickness to achieve the desired performance.

### PROBLEM OF THE PRIOR ART TO BE SOLVED BY THE PRESENT INVENTION

Ellipsometry is used very successfully for thin film applications, especially in the area of semiconductors. However, if the adsorbent layer to be analyzed has an optical index of refraction equal or close to the optical index of refraction of the underlying substrate, the sensitivity of ellipsometric detection is very limited. This is because in such cases the adsorbent layer does not form an optical significant interface to the substrate, so that no or only weak optical interference occurs at this interface. A change in thickness of the adsorbent layer is therefore comparable to a change in thickness of the underlying substrate and merely results in a detectable phase shifting effect. Very often glass or transparent plastic materials are the preferred substrate materials to be used in order to measure biological materials. Unfortunately, the optical index of refraction of biological materials like proteins or DNA is close to that of glass or transparent plastic materials, limiting the sensitivity of ellipsometric detection for the case of organic material adsorbed to such a substrate.

It is therefore the goal of the present invention to disclose substrate samples providing improved optical response in ellipsometric measurements, the improvements resulting from effects other than surface plasmon resonances. Improvements in this context means either increased sensitivity and/or better linearity and/or increased dynamic range for the measurement of the adsorbent layer.

### DISCLOSURE OF THE INVENTION

The problem is solved by applying to the substrate an amplification layer system comprising at least one dielectric layer with an optical index of refraction significantly different from the adsorbent layer to be detected. As a consequence at least one optical significant interface is established between the adsorbent layer and the substrate and optical interference effects get more pronounced. The dielectric layer system can be chosen in such a way that a change of thickness of the adsorbent layer results in significant phase shifting and therefore leads to improved optical response in ellipsometric measurement.

To optimize the design of the amplification layer system, the response of the ellipsometric angles as a function of the thickness of the adsorbent layer has to be calculated. The calculation itself can be done by well-known procedures, as described in R. M. A. Azzam, and N. M. Bashara, Ellipsometry and Polarized Light, North Holland Press, Amsterdam 1977. In order to establish increased sensitivity the goal of the optimisation is a large slope of the measured ellipsometric angle (usually the Delta is more sensitive for very thin films) as a function of layer thickness of the adsorbent layer. A larger slope indicates a higher sensitivity. However, at the same time the signal response at the detector during the measurement procedure must also be sufficient. Equations for the detector response of ellipsometers are also given in R. M. A. Azzam, and N. M. Bashara, Ellipsometry and Polarized Light, North Holland Press, Amsterdam 1977.

By balancing both signal response and Delta slope, an optimum sensitivity for the practical measurement can be found for a certain design of the intermediate layer system according to the present invention.

If the object is to realize a linear response of the biosensor in a certain thickness range of the adsorbent layer, the layout of the amplification layer system can be modeled according to the method described above with the optimization goal modified in such a way, that designs providing linearity of optical response are preferred.

In one embodiment of the present invention the amplification layer system comprises just one single dielectric layer. The index of refraction of this layer is either below or above the index of the adsorbent layer. However in another embodiment of the present invention the intermediate layer system comprises multiple layers of materials with alternating index of refraction

Depending on the optical design of the intermediate layer system the sensor works at various angles of incidence, including but not necessarily TIR conditions.

The amplification layer system may comprise linker chemistry and/or contact layers and/or activation layers and/or other additional intermediate layers required to create desired surface chemical properties.

### DETAILED DESCRIPTION OF THE INVENTION

Since the optimum layout of the amplification layer system depends on the operation conditions of the biosensor, we describe as an example a measurement set-up using a PCSA-ellipsometer for the measurement of binding kinetic. Such an apparatus comprises a light source that emits a collimated light beam passing a variable polarization controller given by the combination of a first linear polarizer (P) and an compensator in the form of a quarter-wave plate (C). The polarised light beam is incident on the sample substrate (S) under a known oblique angle, reflected from a sensing surface of the sample substrate and analyzed by a second linear polarizer (A) with the help of a photodetector.

For such measurements the sensing surface has to be in contact with the solution of the molecular species to adsorb or bind to it. Preferably this is in a flow cell that allows a controlled flow of analyte over the surface, or in the well of a microplate. The sensing surface forms the bottom of such a flow cell or well in a microplate, with a beam of light propagating through the substrate of the substrate sample to the sensing surface and being reflected at the sensing surface.

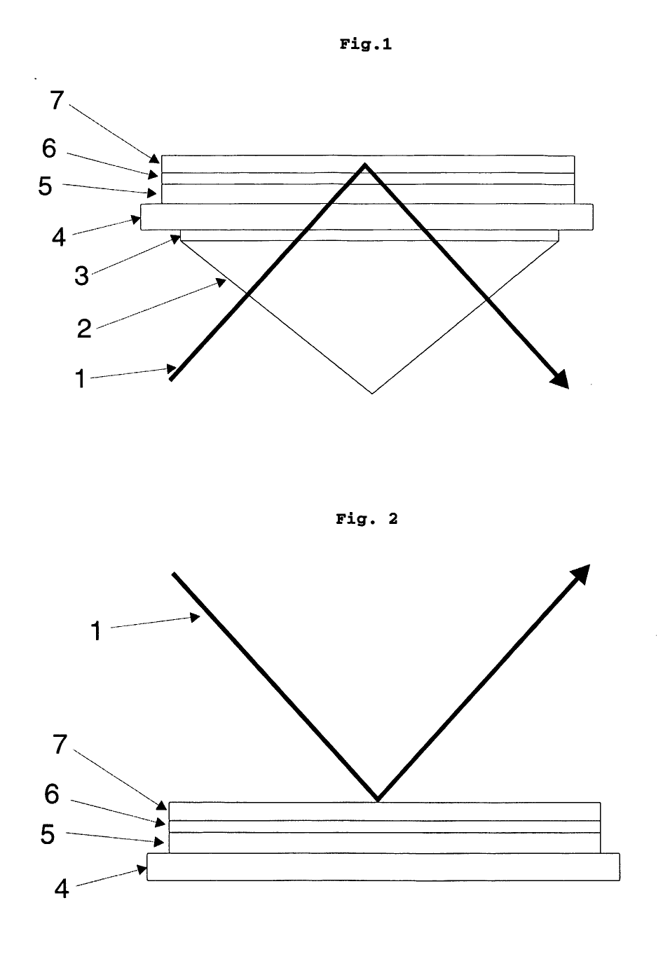

In our example, during the measurement a light beam 1 enters a coupling prism 2 and transmits through an optical contact layer 3 to the substrate 4 and the adsorbent layer 7 as is shown in FIG. 1.

The coupling prism 2 is used in order to illuminate the sensing surface through the substrate 4 with an angle of incidence which is above the critical angle of total internal reflection. As the sensitivity of ellipsometry strongly depends on the angle of incidence, it is favorable to get to higher internal angles by the use of a coupling prism 2.

However, a direct illumination resulting in lower internal angles without the need for a prism or other coupling device might still lead to sufficient sensitivity for some applications by using a proper amplification layer and would in this case be a preferred solution. In our example the coupling prism 2 is made of BK7, however any other transmitting glass or plastic types could be used. In some cases it might be advantageous to use glass with low stress birefringence in order to avoid depolarization effects.

The optical contact layer 3 is used to avoid additional reflections form the interface between coupling prism 2 and substrate 4. The optical contact layer 3 could be index matching fluid such as for example index matching oil.

As can be seen from FIG. 1 the amplification layer system 5 according to the present invention is provided on the top surface of the substrate 4. In our example the amplification layer system 5 comprises a single dielectric layer of a high-optical index of refraction material which is deposited on a glass substrate. The layer has a thickness that allows for a highly sensitive and linear measurement of the organic adsorbent layer. The thickness of this single dielectric layer is crucial to act as the amplification layer and deduced from optical modeling as described above.

As an example we modeled a system which comprises a glass substrate 4 with an optical index of refraction of 1.52, e.g. BK7, an amplification layer system with a single dielectric layer with an optical index of refraction of 2.2, e.g. Ta₂O₅ and variable thickness of 0-150 nm. On top of this amplification layer a 10 nm layer of SiO₂ with an optical index of refraction of 1.46 is applied in order to provide a contact layer for the adsorbent layer. (More details why such a contact layer is applied are given below). The adsorbent layer has an optical index of refraction of 1.5. The ambient medium is assumed to be water with an optical index of refraction of 1.333, the wavelength is 632.8 nm and the angle of incidence within the glass substrate is 60 degrees, requiring a prism or other optical coupler.

Table 1 gives a comparison of the ellipsometric performance of a kinetics sensor with and without amplification layer as simulated by optical modeling. The comparison is based on a Figure of Merit (FOM) that takes into account the measuring and data analysis process of a PCSA nulling ellipsometer as described above. The definition is such that the sensor without amplification layer has a FOM of 1. As may be seen from Table 1, a maximum FOM of approx. 30 may be achieved for a 90 nm thick amplification layer, corresponding to a 30-fold increase of sensitivity for the detection of a thin layer of adsorbent molecules. Therefore the optimum thickness for the amplification layer of this example is 90 nm, however a layer thickness from 70 nm to 100 nm shows good performance as well. There are a number of details and alternatives we discuss in the following:

a) Amplification Layer System

In our example as discussed above we used a thin layer of Ta₂O₅ as amplification layer system. However other materials such as Nb₂O₅, TiO₂, HfO₂ or ZrO₂ may equally be used. Nitrides like Si₃N₄ can also be used and even Si at IR wavelengths. In principle, any other typical thin film material having a optical index of refraction above or below the index of the adsorbent layer can be used. One example for a low index material would by MgF₂.

In addition it is possible to optimize and use an optical multilayer system as amplification layer system. Such a multilayer system may comprise alternating high and low index layers. In order to model such systems known transfer matrix methods can be applied. In order to optimize such systems known optimization techniques such as for example genetic algorithms or simulated thermal annealing methods can be applied. Due to the increased number of parameters (thicknesses of the layers) there is a high degree of freedom for optimizing for desired optical responses. As an example, we modeled the effect of increasing the layer thickness of the SiO₂ layer in the example above, which now not only acts as a contact layer but effectively becomes a part of the amplification layer structure. Starting with the optimized single amplification layer of Ta2O₅ with a thickness of 90 nm we now vary the thickness of the former contact layer of SiO₂ in the range of 10 nm to 280 nm. The results for a Figure of Merit defined as above are given in Table 2. It shows, that at a thickness of 250 nm for the SiO₂ layer the double amplification layer structure further increases the theoretical sensitivity for the binding of the adsorbant layer by a factor of 3.

It should be noted that the overall reflection is a coherent and incoherent superposition of reflected components at all involved optical interfaces. Some of them have been omitted in FIG. 1 for the sake of clarity.

b) Contact Layer

In our first example as described we applied a 10 nm SiO2 layer on top of the amplification layer. This contact layer 6 was applied to further facilitate the attachment of a chemically specific sensing layer. Such a contact layer 6 may always be applied on top of the amplification layer system 5, provided that it is at least partly transparent and its optical effect is well within the dynamic range of the sensor. In a preferred form, this contact layer comprises a thin layer of SiO2 of a few nanometers, followed by silane based linker chemistry and/or other intermediate layers and finally the chemically sensitive layer, e.g. immobilized antibodies.

On the other hand such a contact layer may be attributed as well as a part of the amplification layer system. Then the optimization according to the present invention takes the optical effect of this contact layer into account. Sometimes the thickness of the contact layer itself can be used as well as optimization parameter, as was shown above.

c) Illumination Means

In our example we used a prism in order to provide illumination above the critical angle of total internal reflection. Instead of the prism alternatively a grating coupler on the bottom side of the glass substrate 4 might be used.

d) Imaging Ellipsometry

Attaching this sensor to a flow cell integrated with an ellipsometer allows a measurement of the thickness or surface coverage of the adsorbant layer 7 forming from the solution of the analyte, or a binding kinetics. By applying imaging ellipsometry this biosensor is able to monitor multiple binding sites or spots simultaneously in a massively parallel way.

e) Alternatives of Ellipsometer Setups and Applications

Alternative forms of this sensor include the incorporation into microplates as the bottom plate, where each well forms an individually enclosed biosensor, or an inverted design for usage with microarrays in air, e.g. for high throughput screening, where the light beam 1 is coming from the air side according to FIG. 2. Again, the thickness of the amplification layer system 5 is optimized by optical modeling. By compromising the maximum performance it is also possible to design the sensor substrate for usage in both liquid or air ambient.

f) Multiple Sub Areas

Another modification is to divide a single binding site into multiple sub-areas each with maximum sensitivity for a certain adsorbent layer thickness or surface coverage by compromising the dynamic range or the linearity. This may be achieved by patterning of the amplification layer and optimizing its thickness locally. In a further modification, sub-areas that allow for an internal calibration or acting as a reference channel to compensate the effect of non-specific binding or temperature drift of the ellipsometric signal may be included.

For the use with microplates or other applications requiring a large area with multiple detection sites to be analyzed, a possible modification would use local grating structures, microprisms or embossed surface relief structure to couple-in the light beam for each individual well or detection site.

g) Combination with Fluorescence Methods

Another modification is the combination with grating and guided mode fluorescence based detection such as WO 95/33197 and U.S. Pat. No. 2002/135780. The grating structure does not disturb in case that the detection is done in off-resonance mode.

TABLE 1

| thickness of | |
|---|---|
| amplification | Figure of |
| layer (nm) | Merit |
| 0 | 1 |
| 5 | 3.1 |
| 10 | 7.2 |
| 20 | 16.0 |
| 30 | 22.2 |
| 50 | 27.8 |
| 70 | 29.4 |
| 90 | 29.7 |
| 110 | 29.4 |
| 130 | 27.8 |
| 150 | 21.4 |

TABLE 2

| thickness of | |
|---|---|
| SiO₂ layer | Figure of |
| (nm) | Merit |
| 10 | 29.7 |
| 100 | 31.2 |
| 200 | 46.3 |
| 220 | 63.3 |
| 240 | 87.6 |
| 250 | 90.3 |
| 260 | 82.3 |
| 280 | 57.9 |

1. A method for analyzing organic adsorbent layers on a substrate, the method comprising the following steps:
providing a substrate with a surface, the substrate having an index of refraction equal or close to the index of refraction of the organic adsorbent to be analyzed
applying a layer system to the surface of the substrate, the layer system comprising at least one layer with index of refraction significantly different from the index of refraction of the biological material;
applying the organic adsorbent layer on top of the layer system
act polarized light upon the substrate
detect in reflection and/or transmission the change of polarization characteristics of the light acted upon the substrate.

2. Method according to claim 1 comprising the step of detecting the reflection and/or transmission amplitude of the light acted upon the substrate.

3. Method according to one of the previous claims comprising the step of selecting the substrate material out of the group of glass and plastic materials.

4. A method according to one of the previous claims characterized in that said at least one layer is chosen out of the group of Ta₂O₅, Nb₂O₅, TiO₂, HfO₂, ZrO₂ MgF₂.

5. Method according to one of the previous claims comprising the step of optimizing the layer thickness distribution of the layer system in order to provide optical response allowing for desired, preferably maximum sensitivity with respect to changes in the adsorbent layer to be analyzed.

6. Method according to one of the previous claims comprising the step of selecting SiO₂ as top layer forming the interface to a contact layer and/or the adsorbent layer to be analyzed.

7. Method according to one of the previous claims comprising the steps of applying a structured layer system thereby creating multiple subareas with maximum sensitivity for different adsorbent layer characteristics.

8. Method of performing imaging ellipsometry comprising the steps of one of the methods according to one of the previous claims.
